(19) United States
(12) Patent Application Publication
(10) Pub. No.: US 2026/0181451 A1
(43) Pub. Date: Jun. 25, 2026

(54) POSITIONING TRIGGERING

(71) Applicant: Nokia Technologies Oy, Espoo (FI)

(72) Inventors: Yong LIU, Shanghai (CN); Yan MENG, Shanghai (CN); Diomidis MICHALOPOULOS, Munich (DE); Mikko SÄILY, Espoo (FI); Jan Torst HVIID, Aalborg (DK); Knud KNUDSEN, Aalborg (DK)

(21) Appl. No.: 19/129,034

(22) PCT Filed: Nov. 12, 2022
(86) PCT No.: PCT/CN2022/131577

§ 371 Date: May 12, 2025

(51) Int. Cl. H04W 24/10; H04W 64/00

(52) U.S. Cl. CPC H04W 24/10; H04W 64/00

(57) ABSTRACT

Embodiments of the present disclosure relate to devices, methods, apparatuses, and computer readable storage media for positioning triggering. In a method, a terminal device receives a positioning configuration that indicates one or more thresholds. The one or more thresholds are used for triggering, based on sidelink communication associated with the terminal device, positioning measurement or reporting of the positioning measurement at the terminal device. The terminal device triggers the positioning measurement or the reporting of the positioning measurement based on the one or more thresholds indicated in the positioning configuration.

### FIELDS

Various example embodiments of the present disclosure generally relate to the field of telecommunication and in particular, to devices, methods, apparatuses and computer readable storage medium for positioning triggering.

### BACKGROUND

Reduced Capability (RedCap) user equipment (UEs) are provided with reduced bandwidths and reduced complexity to have a relatively longer battery life. Redcap UEs are targeted for some specific use cases, such as industrial wireless sensors, video surveillance, wearables, and goods tracking to reduce the cost and complexity in comparison to legacy UEs. Positioning support is required for RedCap UEs. RedCap UEs may be configured to perform periodic positioning measurement or reporting of the measured positioning results to a network. However, RedCap UEs are of limited power and hence may not afford such continuous positioning measurement and reporting.

### SUMMARY

In a first aspect of the present disclosure, there is provided a terminal device. The terminal device includes at least one processor; and at least one memory storing instructions that, when executed by the at least one processor, cause the terminal device at least to: receive a positioning configuration that indicates one or more thresholds for triggering, based on sidelink communication associated with the terminal device, positioning measurement or reporting of the positioning measurement at the terminal device; trigger the positioning measurement or the reporting of the positioning measurement based on the one or more thresholds indicated in the positioning configuration.

In a second aspect of the present disclosure, there is provided a network node. The network node includes at least one processor; and at least one memory storing instructions that, when executed by the at least one processor, cause the network node at least to: transmit, to a terminal device, a positioning configuration that indicates one or more thresholds for triggering, based on sidelink communication associated with the terminal device, positioning measurement or reporting of the positioning measurement at the terminal device; and receive, from the terminal device, a report of the positioning measurement, the positioning measurement or the reporting of the positioning measurement being triggered by the terminal device based on the one or more thresholds indicated in the positioning configuration.

In a third aspect of the present disclosure, there is provided a location management function. The location management function includes at least one processor; and at least one memory storing instructions that, when executed by the at least one processor, cause the location management function at least to: transmit, to a terminal device, via a network node, a positioning configuration that indicates one or more thresholds for triggering, based on sidelink communication associated with the terminal device, positioning measurement or reporting of the positioning measurement at the terminal device; and receive, from the terminal device, via the network node, a report of the positioning measurement, the positioning measurement or the reporting of the positioning measurement being triggered by the terminal device based on the one or more thresholds indicated in the positioning configuration.

In a fourth aspect of the present disclosure, there is provided a method. The method includes: at a terminal device, receiving a positioning configuration that indicates one or more thresholds for triggering, based on sidelink communication associated with the terminal device, positioning measurement or reporting of the positioning measurement at the terminal device; and triggering the positioning measurement or the reporting of the positioning measurement based on the one or more thresholds indicated in the positioning configuration.

In a fifth aspect of the present disclosure, there is provided a method. The method includes: at a network node, transmitting, to a terminal device, a positioning configuration that indicates one or more thresholds for triggering, based on sidelink communication associated with the terminal device, positioning measurement or reporting of the positioning measurement at the terminal device; and receiving, from the terminal device, a report of the positioning measurement, the positioning measurement or the reporting of the positioning measurement being triggered by the terminal device based on the one or more thresholds indicated in the positioning configuration.

In a sixth aspect of the present disclosure, there is provided a method. The method includes: at a location management function, transmit, to a terminal device, via a network node, a positioning configuration that indicates one or more thresholds for triggering, based on sidelink communication associated with the terminal device, positioning measurement or reporting of the positioning measurement at the terminal device; and receive, from the terminal device, via the network node, a report of the positioning measurement, the positioning measurement or the reporting of the positioning measurement being triggered by the terminal device based on the one or more thresholds indicated in the positioning configuration.

In a seventh aspect of the present disclosure, there is provided an apparatus. The apparatus includes means for receiving a positioning configuration that indicates one or more thresholds for triggering, based on sidelink communication associated with the terminal device, positioning measurement or reporting of the positioning measurement at the terminal device; means for triggering the positioning measurement or the reporting of the positioning measurement based on the one or more thresholds indicated in the positioning configuration.

In an eighth aspect of the present disclosure, there is provided an apparatus. The apparatus includes means for transmitting, to a terminal device, a positioning configuration that indicates one or more thresholds for triggering, based on sidelink communication associated with the terminal device, positioning measurement or reporting of the positioning measurement at the terminal device; and means for receiving, from the terminal device, a report of the positioning measurement, the positioning measurement or the reporting of the positioning measurement being triggered by the terminal device based on the one or more thresholds indicated in the positioning configuration.

In a ninth aspect of the present disclosure, there is provided an apparatus. The apparatus includes means for transmitting, to a terminal device, via a network node, a positioning configuration that indicates one or more thresholds for triggering, based on sidelink communication associated with the terminal device, positioning measurement or reporting of the positioning measurement at the terminal device; and means for receiving, from the terminal device, via the network node, a report of the positioning measurement, the positioning measurement or the reporting of the positioning measurement being triggered by the terminal device based on the one or more thresholds indicated in the positioning configuration.

In a tenth aspect of the present disclosure, there is provided a computer readable medium. The computer readable medium includes instructions stored thereon for causing an apparatus to perform at least the method according to the fourth, fifth or sixth aspect.

It is to be understood that the Summary section is not intended to identify key or essential features of embodiments of the present disclosure, nor is it intended to be used to limit the scope of the present disclosure. Other features of the present disclosure will become easily comprehensible through the following description.

### BRIEF DESCRIPTION OF THE DRAWINGS

Some example embodiments will now be described with reference to the accompanying drawings, where:

FIG. 1 illustrates an example communication environment in which example embodiments of the present disclosure can be implemented;

FIG. 2 illustrates a flowchart of a method implemented at a terminal device according to some example embodiments of the present disclosure;

FIG. 3 illustrates an example signaling diagram of a positioning process according to some example embodiments of the present disclosure;

FIG. 4 illustrates a flowchart of a method implemented at a network node according to some example embodiments of the present disclosure;

FIG. 5 illustrates a flowchart of a method implemented at a location management function (LMF) according to some example embodiments of the present disclosure;

FIG. 6 illustrates a simplified block diagram of a device that is suitable for implementing example embodiments of the present disclosure; and

FIG. 7 illustrates a block diagram of an example computer readable medium in accordance with some example embodiments of the present disclosure.

Throughout the drawings, the same or similar reference numerals represent the same or similar element.

### DETAILED DESCRIPTION

Principle of the present disclosure will now be described with reference to some example embodiments. It is to be understood that these embodiments are described only for the purpose of illustration and help those skilled in the art to understand and implement the present disclosure, without suggesting any limitation as to the scope of the disclosure. Embodiments described herein can be implemented in various manners other than the ones described below.

In the following description and claims, unless defined otherwise, all technical and scientific terms used herein have the same meaning as commonly understood by one of ordinary skills in the art to which this disclosure belongs.

References in the present disclosure to “one embodiment,” “an embodiment,” “an example embodiment,” and the like indicate that the embodiment described may include a particular feature, structure, or characteristic, but it is not necessary that every embodiment includes the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

It shall be understood that although the terms “first,” “second” and the like may be used herein to describe various elements, these elements should not be limited by these terms. These terms are only used to distinguish one element from another. For example, a first element could be termed a second element, and similarly, a second element could be termed a first element, without departing from the scope of example embodiments. As used herein, the term “and/or” includes any and all combinations of one or more of the listed terms.

As used herein, “at least one of the following: <a list of two or more elements>” and “at least one of <a list of two or more elements>” and similar wording, where the list of two or more elements are joined by “and” or “or”, mean at least any one of the elements, or at least any two or more of the elements, or at least all the elements.

As used herein, unless stated explicitly, performing a step “in response to A” does not indicate that the step is performed immediately after “A” occurs and one or more intervening steps may be included.

The terminology used herein is for the purpose of describing particular embodiments only and is not intended to be limiting of example embodiments. As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof.

As used in this application, the term “circuitry” may refer to one or more or all of the following:
(a) hardware-only circuit implementations (such as implementations in only analog and/or digital circuitry) and
(b) combinations of hardware circuits and software, such as (as applicable):
   (i) a combination of analog and/or digital hardware circuit(s) with software/firmware and
   (ii) any portions of hardware processor(s) with software (including digital signal processor(s)), software, and memory(ies) that work together to cause an apparatus, such as a mobile phone or server, to perform various functions) and
(c) hardware circuit(s) and or processor(s), such as a microprocessor(s) or a portion of a microprocessor(s), that requires software (e.g., firmware) for operation, but the software may not be present when it is not needed for operation.

This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example and if applicable to the particular claim element, a baseband integrated circuit or processor integrated circuit for a mobile device or a similar integrated circuit in server, a cellular network node, or other computing or network node.

As used herein, the term “communication network” refers to a network following any suitable communication standards, such as New Radio (NR), Long Term Evolution (LTE), LTE-Advanced (LTE-A), Wideband Code Division Multiple Access (WCDMA), High-Speed Packet Access (HSPA), Narrow Band Internet of Things (NB-IoT) and so on. Furthermore, the communications between a terminal device and a network node in the communication network may be performed according to any suitable generation communication protocols, including, but not limited to, the first generation (1G), the second generation (2G), 2.5G, 2.75G, the third generation (3G), the fourth generation (4G), 4.5G, the fifth generation (5G) communication protocols, and/or any other protocols either currently known or to be developed in the future. Embodiments of the present disclosure may be applied in various communication systems. Given the rapid development in communications, there will of course also be future type communication technologies and systems with which the present disclosure may be embodied. It should not be seen as limiting the scope of the present disclosure to only the aforementioned system.

As used herein, the term “network node” refers to a node in a communication network via which a terminal device accesses the network and receives services therefrom. The network node may refer to a base station (BS) or an access point (AP), for example, a node B (NodeB or NB), an evolved NodeB (eNodeB or eNB), an NR NB (also referred to as a gNB), a Remote Radio Unit (RRU), a radio header (RH), a remote radio head (RRH), a relay, an Integrated Access and Backhaul (IAB) node, a low power node such as a femto, a pico, a non-terrestrial network (NTN) or non-ground network node such as a satellite network node, a low earth orbit (LEO) satellite and a geosynchronous earth orbit (GEO) satellite, an aircraft network node, and so forth, depending on the applied terminology and technology. In some example embodiments, radio access network (RAN) split architecture includes a Centralized Unit (CU) and a Distributed Unit (DU) at an IAB donor node. An IAB node includes a Mobile Terminal (IAB-MT) part that behaves like a UE toward the parent node, and a DU part of an IAB node behaves like a base station toward the next-hop IAB node.

The term “terminal device” refers to any end device that may be capable of wireless communication. By way of example rather than limitation, a terminal device may also be referred to as a communication device, user equipment (UE), a Subscriber Station (SS), a Portable Subscriber Station, a Mobile Station (MS), or an Access Terminal (AT). The terminal device may include, but not limited to, a mobile phone, a cellular phone, a smart phone, voice over IP (VOIP) phones, wireless local loop phones, a tablet, a wearable terminal device, a personal digital assistant (PDA), portable computers, desktop computer, image capture terminal devices such as digital cameras, gaming terminal devices, music storage and playback appliances, vehicle-mounted wireless terminal devices, wireless endpoints, mobile stations, laptop-embedded equipment (LEE), laptop-mounted equipment (LME), USB dongles, smart devices, wireless customer-premises equipment (CPE), an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. The terminal device may also correspond to a Mobile Termination (MT) part of an IAB node (e.g., a relay node). In some example embodiments, the terminal device may be a Reduced Capability (RedCap) UE, also referred to a RedCap device. In the following description, the terms “terminal device”, “communication device”, “terminal”, “user equipment” and “UE” may be used interchangeably.

As used herein, the term “resource,” “transmission resource,” “resource block,” “physical resource block” (PRB), “uplink resource,” or “downlink resource” may refer to any resource for performing a communication, for example, a communication between a terminal device and a network node, such as a resource in time domain, a resource in frequency domain, a resource in space domain, a resource in code domain, or any other resource enabling a communication, and the like. In the following, unless explicitly stated, a resource in both frequency domain and time domain will be used as an example of a transmission resource for describing some example embodiments of the present disclosure. It is noted that example embodiments of the present disclosure are equally applicable to other resources in other domains.

As used herein, the term “location management function” (LMF) refers to a device that provides positioning-related services to a terminal device. The location management service may include location update and tracking and other positioning-related service of the terminal device. The LMF may be implemented by a device physically separate from or integrated into the network node.

As used herein, the term “positioning measurement” refers to measurement performed by a terminal device for the positioning purpose. The measurements may be based on a positioning reference signal (PRS) transmitted by the network node. Based on the positioning measurement, a location of the terminal device can be determined using various positioning techniques such as Downlink Time Difference of Arrival (DL-TDOA), Uplink Time Difference of Arrival (UL-TDOA), Downlink Angle of Departure (DL-AoD), Uplink Angle of Arrival (UL-AoA), Multi-cell Round Trip Time (Multi-RTT), RF fingerprinting, database matching, and the like. In addition, various artificial intelligence-based position algorithms can be used based on the positioning measurements.

As used herein, the term “sidelink” (SL) refers to a communication link between terminal devices. Resources via sidelink may be configured by the network.

For the positioning purpose, RedCap UEs may be configured to perform periodic positioning measurement or reporting of the measured results or positioning information to a network. However, such continuous positioning measurement and reporting may not be suitable for RedCap UEs which are driven by the constraint of low energy consumption.

Particularly, in the use case of goods tracking, tag UEs for goods, which may be RedCap UEs, may be put in a moving cart or a room where an anchor UE may be arranged which may be a non-RedCap UE. In this case, a group of RedCap and non-RedCap UEs in proximity may mostly be relatively static for certain time. For the tracking purpose (for example, goods tracking), positioning accuracy requirements for RedCap UEs are low, and thus the positioning of the anchor UE may fulfil the accuracy requirements for nearby RedCap UEs. In this situation, the positioning of the anchor UE in the cart or in the room may be good enough for tracking. Only if a tag UE moves away from the anchor UE, it may need to perform the positioning related operations.

Example embodiments of the present disclosure propose a positioning triggering mechanism for a terminal device such as a RedCap UE to achieve power saving. With the mechanism, a terminal device conditionally triggers positioning measurement or reporting of the positioning measurement based on one or more thresholds indicated in a positioning configuration. Based on the one or more thresholds, the positioning measurement or the reporting thereof is triggered by the terminal device according to sidelink communication associated with the terminal device.

This mechanism may allow a Redcap UE to stop the positioning measurement or the reporting thereof at a Uu interface with a gNB and rely on a nearby device (such as an anchor UE) to provide the positioning related information for tracking purpose. The positioning at the Uu interface may be triggered based on a sidelink measurement of an indication signal at a sidelink interface. In this way, prompt positioning and tracking may be provided for a terminal device with reduced power consumption.

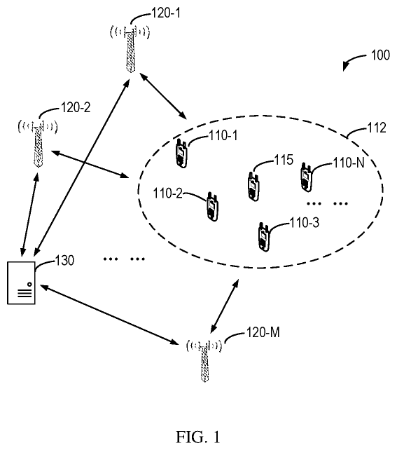

FIG. 1 illustrates an example communication environment 100 in which example embodiments of the present disclosure can be implemented.

The communication environment 100 includes a plurality of terminal devices 110-1, 110-2, 110-3, . . . , 110-N (where N represents any suitable positive integer) which will be individually or collectively referred to as a terminal device 110. In this example, as shown in FIG. 1, the terminal devices 110-1, 110-2, 110-3, . . . , 110-N, which may be RedCap UEs, may be put in a space 112, such as a cart or a room, where an anchor node 115 may be located. The anchor node 115 may be a non-RedCap UE, a rotating RedCap UE, or a dedicated node used to save power for nearby devices in positioning. The plurality of terminal devices 110 and the anchor node 115 are in proximity and may be relatively static for certain time. The terminal devices 110 may communicate with each other and with the anchor node 115 via a sidelink interface.

The environment 100 further includes a plurality of network nodes 120-1, 120-2, . . . , 120-M (where M represents any suitable positive integer) which will be individually or collectively referred to as a network node 120. The terminal devices 110 and the anchor node 115 may communicate with the network node 120 via an interface such as a NR Uu interface.

As shown in FIG. 1, in the environment 100, a LMF 130 provides positioning-related services to the terminal devices 110. For example, the LMF 130 may track locations of the terminal devices 110, identify movement states of the terminal devices 110, and/or the like. The terminal device 110 may communicate with the LMF 130 directly or via the network node 120. The LMF 130 and the network node 120 may communicate over wireless and/or wired means.

In some example embodiments, the LMF 130 may determine locations of the terminal devices 110 based on the positioning-related reporting from the terminal devices 110 via the network node 120. In some other example embodiments, the LMF 130 may determine the locations of the terminal devices 110 based on the positioning-related reporting from the anchor node 115 since the terminal devices 110 and the anchor node 115 are close to each other and are relatively static for certain time.

It is to be understood that the LMF 130 is shown to be physically separate from the network node 120 only for the purpose of illustration, without suggesting any limitation. The LMF 130 may be implemented by a physical or virtual device. The LMF 130 may be implemented as a hardware, firmware and/or algorithm-based software component within any device (such as the terminal device 110, the network node 120, and/or the like) that can provide the positioning-related service. In some example embodiments, the LMF 130 may be physically integrated into or a part of the network node 120.

It is also to be understood that the types of devices and the numbers of different types of devices are shown in FIG. 1 only for the purpose of illustration, without suggesting any limitations. The environment 100 may include any other types of devices and any number of terminal devices, anchor nodes, network nodes and LMFs adapted for implementing example embodiments of the present disclosure.

Communications in the environment 100 may utilize any suitable wireless communication technology, including, but not limited to: Code Division Multiple Access (CDMA), Frequency Division Multiple Access (FDMA), Time Division Multiple Access (TDMA), Frequency Division Duplex (FDD), Time Division Duplex (TDD), Multiple-Input Multiple-Output (MIMO), Orthogonal Frequency Division Multiple (OFDM), Discrete Fourier Transform spread OFDM (DFT-s-OFDM) and/or any other technologies currently known or to be developed in the future.

In the positioning of the terminal device 110, the terminal device 110 may periodically measure a positioning reference signal (PRS) from the network node 120 and report the measured results to the LMF 130 via the network node 120. Based on measured results, the LMF 130 may determine a location of the terminal device 110 based on positioning techniques.

In various example embodiments, the terminal device 110 conditionally triggers the positioning measurement or the reporting of the positioning measurement to reduce the power consumption. In a time period when the positioning measurement is stopped, the terminal device 110 may be tracked by means of the positioning of nearby devices such as the anchor node 115. The positioning measurement may be triggered by the terminal device 110 based on one or more thresholds that are configured by the network based on the sidelink communication associated with the terminal device 110.

For example, the sidelink communication may include communication between the terminal device 110 and the anchor node 115 over sidelink. If the level of indication signal measurement over the sidelink is higher, which means that the terminal device 110 is closer enough to the anchor node 115 or substantially within the space 112 or boundary, then the terminal device 110 may stop the positioning-related operation and rely on the positioning of the anchor node 115. If the level of indication signal measurement over the sidelink is lower, which means that the terminal device 110 is far away from the anchor node 115 or substantially beyond the space 112 or boundary, the terminal device 110 may trigger its own positioning measurement.

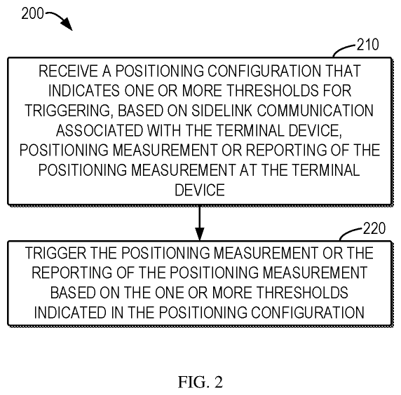

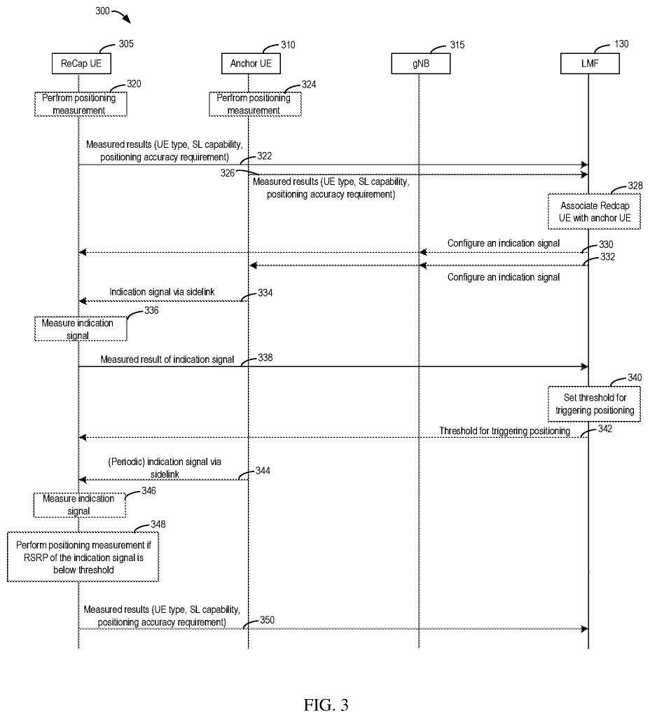

Some example embodiments of the present disclosure will be described in detail below with reference to FIGS. 2 and 3.

FIG. 2 shows a flowchart of an example method 200 implemented at the terminal device 110 in accordance with some example embodiments of the present disclosure. For the purpose of discussion, the method 200 will be described with reference to FIGS. 1 and 3.

At block 210, the terminal device 110 receives a positioning configuration (e.g., step 342 in FIG. 3) that indicates one or more thresholds. The one or more thresholds are used for triggering, based on sidelink communication associated with the terminal device 110, the positioning measurement or reporting of the positioning measurement at the terminal device 110.

The sidelink communication may include indication signal measurement performed by the terminal device 110 at a sidelink interface, also referred to as sidelink measurement (e.g., steps 336 and 346 in FIG. 3). In some example embodiments, the sidelink measurement may include measurement by the terminal device 110, of an indication signal communicated from the anchor node 115 via sidelink (e.g., steps 334 and 344). The indication signal (e.g., steps 334 and 344) may be a packet or a sequence which may be configured for the anchor node 115 by the network node 120 or by the LMF 130, to broadcast to nearby devices via a sidelink interface. Alternatively, or in addition, another terminal device 110, instead of the anchor node 115, may broadcast the indication signal via a sidelink interface. In this way, the positioning measurement at a Uu interface may be stopped or triggered based on the sidelink measurement (e.g., step 346 in FIG. 3) to reduce the power saving.

The anchor node 115 may be selected or determined by the LMF 130 or by the network node 120 to save power for other terminal devices in positioning. The LMF 130 or by the network node 120 may associate the anchor node 115 with the plurality of terminal devices 110 (i.e., 110-1 to 110-N) based on their positions. The anchor node 115 may be a normal UE with less power consumption limitation or a rotating RedCap UE. Alternatively, the anchor node 115 may be a dedicated node or device, such as a network node, which is configured for positioning of the nearby devices.

In some example embodiments, the network node 120 may transmit, to the anchor node 115, a configuration of periodic resources to broadcast the indication signal (e.g., step 332). For example, the network node 120 may perform mode 1 resource allocation at the sidelink interface to configure periodic resources for the anchor node 115 to broadcast the indication signal. Accordingly, the anchor node 115 may periodically broadcast the indication signal via sidelink (steps 334 and 344) to each terminal device 110 of the plurality of terminal devices 110. Alternatively, or in addition, the anchor node 115 may broadcast the indication signal in “one shot” (steps 334 and 344) based on the configuration from the network node 120. Thus, all the terminal devices 110 (i.e., 110-1 to 110-N) around the anchor node 115 may receive the indication signal.

Upon the reception of the indication signal communicated from the anchor node 115, the terminal device 110 may perform the sidelink measurement (step 346) of the indication signal which may reflect the distance between the terminal device 110 and the anchor node 115. Based on comparison of the level of the sidelink measurement with the configured thresholds, the terminal device 110 may determine whether the anchor node 115 is in proximity or substantially within the space 112 or boundary. If the anchor node 115 is near in position, the terminal device 110 may stop the positioning-related operation and rely on the positioning of the anchor node 115. If the anchor node 115 is far away or substantially beyond the space 112 or boundary, the terminal device 110 may trigger its own positioning measurement.

The thresholds for triggering the positioning may be set based on sidelink measurement of the indication signal by the terminal device 110 (e.g., step 336). For the purpose of discussion, the sidelink measurement for setting the thresholds (e.g., step 336) will be referred to as first sidelink measurement, and the sidelink measurement for triggering the positioning (e.g., step 346) will be referred to as second sidelink measurement.

In some example embodiments, the terminal device 110 (or in addition other terminal devices within the space) may transmit a sidelink measurement report (referred to as a sidelink measurement report, step 338) of the indication signal to the LMF 130 via the network node 120, for example, at an interface (for example, an NR Uu interface) between the terminal device 110 and the network node 130. As such, the LMF 130 may be aware of the level of the sidelink measurement of the terminal device 110 (as well as the level of the other terminal devices within the space) and set the thresholds accordingly (step 340). Alternatively, or in addition, the thresholds may be set by the network node 120. Then, the terminal device 110 may receive, from the network node 120, or from the LMF 130 directly or via the network node 120, the positioning configuration (step 342) that indicates the thresholds.

More specifically, the one or more thresholds indicated in the positioning configuration (step 342) may be determined by the network node 120 or by the LMF 130 based on sidelink measurement reports (step 338) from the plurality of terminal devices (i.e., 110-1 to 110-N). For example, the thresholds may be set (step 340) based on the lowest level of the first sidelink measurement (step 336) of the indication signal communicated by the anchor node 115 in the sidelink measurement reports (step 338) from the plurality of terminal devices (i.e., 110-1 to 110-N). In this example, the one or more thresholds (step 342) for triggering positioning measurement may depend on the respective level of sidelink measurement of the terminal device 110 which may be currently the most far away from the anchor node 115. Thus, if the terminal device 110 is not the most far device, the sidelink measurement level of the terminal device 110 may not fall below the threshold or the terminal device 110 may still be close enough to the anchor node 115, without being triggered to perform a positioning measurement.

As an example, the lowest received signal strength of the indication signal in the sidelink measurement reports from among the plurality of terminal devices (i.e., 110-1 to 110-N) may be set as the threshold (step 340) to trigger the positioning measurement of the terminal device 110. Alternatively, the threshold may be set as the lowest received signal strength plus a value or minus a value to provide a margin or space. The received signal strength of the indication signal may be represented in parameters such as a reference signal receiving power (RSRP), a reference signal strength indicator (RSSI), a reference signal receiving quality (RSRQ), or the like.

Alternatively, in another example embodiment, the terminal device 110-1 may receive a sidelink measurement report (step 338) by another neighboring terminal device (e.g., 110-2) over the sidelink. If the level of sidelink measurement at the terminal device 110-1 is higher than the detected level of sidelink measurement in the received sidelink measurement report from another terminal device (e.g., 110-2), which may mean that the level of sidelink measurement at the terminal device 110-1 is not the lowest, then the terminal device 110-1 may not need to send a sidelink measurement report on its measured result (i.e., skipping step 338 for terminal device 110-1) to the LMF 130 to further save the power consumption of the terminal device 110-1.

In some example embodiments, the configured thresholds may include more than one threshold. For example, the threshold to stop the positioning measurement may be different from (for example, lower than) the threshold to trigger the positioning measurement. As such, the terminal device 110 may not need to frequently stop or trigger the positioning measurement, thereby further saving the power consumption.

In some example embodiments, the terminal device 110 may receive a positioning configuration (e.g., step 342 in FIG. 3) that indicates one or more thresholds. The one or more thresholds may be used for triggering, based on sidelink communication associated with the terminal device 110, transmission of positioning-related reference signals (e.g., SRS (sounding reference signal)) from the terminal device 110 to the network node 120 via a NR-Uu interface.

At block 220, the terminal device 110 may trigger the positioning measurement or the reporting of the positioning measurement based on the one or more thresholds indicated in the positioning configuration. In some example embodiments, based on the triggering by the one or more thresholds, the terminal device 110 may stop the positioning measurement or stop the reporting thereof via the interface between the terminal device 110 and the network node 120. Alternatively, or in addition, based on the triggering by the one or more thresholds, the terminal device 110 may perform or report the positioning measurement via the interface between the terminal device 110 and the network node 120. The interface may include a NR-Uu interface to communicate with the network node 120. In this way, the terminal device 110 may not perform the positioning measurement continuously, but may promptly perform the positioning measurement when needed, thereby reducing the power consumption.

In some example embodiments, the terminal device 110 may trigger switching between a sidelink interface and the interface (NR-Uu interface) between the terminal device 110 and the network node 120, to trigger or stop the positioning measurement via the interface between the terminal device 110 and the network node 120.

In some example embodiments, the reporting of the positioning measurement may take place subsequent to the positioning measurement by the terminal device 110 within a defined time duration. Thus, the LMF 130 or the network node 120 may be aware of the information related to the positioning measurement at the terminal device 110 and then track the terminal device 110, or the terminal device 110 may wait until its energy level is sufficient to transmit the positioning measurement reporting.

In some example embodiments, if the one or more thresholds for triggering the positioning are set based on the first sidelink measurement of the indication signal communicated via sidelink, when a measured result (step 346) of the indication signal is below the one or more thresholds, the terminal device 110 may trigger the positioning measurement or the reporting thereof via an interface (e.g., NR-Uu interface) between the terminal device 110 and the network node 120. Alternatively, or in addition, when the measured result of the indication signal is greater than or equal to the one or more thresholds, the terminal device 110 may stop the positioning measurement or stop the reporting of the positioning measurement via the interface (e.g., NR-Uu interface) between the terminal device 110 and the network node 120. In this way, the positioning measurement may be promptly performed at the terminal device 110 with reduced power consumption.

For example, the terminal device 110 may monitor the indication signal (step 346) at the sidelink interface. For further power saving, the terminal device 110 may measure a reference signal receiving power (RSRP) on a physical sidelink control channel (PSCCH). If a RSRP of the indication signal is below a threshold that may be set based on a RSRP of the indication signal, the terminal device 110 may perform positioning measurement (step 348) at a Uu interface. If the measured RSRP of the indication signal is larger than the threshold, the terminal device 110 may stop the positioning measurement (step 348) at the Uu interface to achieve power saving.

In some example embodiments, the terminal device 110 may measure a positioning reference signal (PRS) (step 348) over the interface between the terminal device 110 and the network node 120 for the positioning purpose. Alternatively, or in addition, the terminal device 110 may transmit a positioning measurement report (step 350) of the PRS to the LMF 130 such that the LMF 130 may determine a location of the terminal device 110 accordingly.

In some example embodiments, the measured results of the positioning measurement by the terminal device 110 may include a time difference of arrival (TDOA), an angle of departure (AOD), and/or a reference signal received power (RSRP). For example, the LMF 130 may determine a location of the terminal device 110 using a positioning technique related to the TDOA, AoD, and RSRP. The terminal device 110 may include some additional information in a positioning measurement report (step 322 or 326 or 350), such as device type (for example, UE type such as RedCap), sidelink (SL) capability, and positioning accuracy requirement, to assist the LMF 130 in the positioning of the terminal device 110.

In some example embodiments, the terminal device 110 may trigger the transmission of positioning-related reference signal (for example, SRS (sounding reference signal)) to the network node 120 via the NR-Uu interface based on the one or more thresholds indicated in the positioning configuration.

FIG. 3 shows an example signaling diagram of a positioning process 300 according to some example embodiments of the present disclosure.

In this example, a Redcap UE 305 is an example of the terminal device 110, an anchor UE 310 is an example of the anchor node 115, and a gNB 315 is an example of the network node 120.

As shown in FIG. 3, in the process 300, the RedCap UE 305 may perform (320) the positioning measurement at a Uu interface. The RedCap UE 305 may report (322) the measured results at a Uu interface to the LMF 130. Alternatively, or in addition, the RedCap UE 305 may perform the positioning measurement by itself and may report a positioning result (step 322) to the LMF 130. The RedCap UE 305 may include the following extra information in the report: UE type (RedCap), SL capability, and positioning accuracy requirement.

Alternatively, or in addition, the anchor UE 310 may also perform (324) the positioning measurement at a Uu interface and report (326) the measured results (or a positioning result) to the LMF 130. Similar to the RedCap UE 305, the anchor UE 310 may include UE type (RedCap or non-RedCap), SL capability, and positioning accuracy requirement in the report.

The LMF 130 may associate (328) the RedCap UE 305 with the anchor UE 310 based on their positions. A UE may be selected by the LMF 130 as the anchor UE 310 which may be a normal UE with less power consumption limitation or a rotating RedCap UE to save power for each RedCap UE.

The LMF 130 may configure (330) an indication signal to the RedCap UE 305 and also configure (332) the indication signal to the anchor UE 310 to be broadcast by the anchor UE 310 to RedCap UEs at a sidelink interface, via the gNB 315. The gNB 315 may perform mode 1 resource allocation at the sidelink interface to configure periodic resources for the anchor UE 310 to broadcast the indication signal.

The anchor UE 310 may broadcast (334) the indication signal to one or more RedCap UEs including the RedCap UE 305 at a sidelink interface. The one or more RedCap UE 305 may measure (336) the indication signal at the sidelink interface and report (338) the sidelink measured result of the indication signal to the LMF 130.

The LMF 130 may base on one or more sidelink measured results (step 338) from the one or more RedCap UE 305 and set (step 340) a threshold to be used to trigger positioning at the one or more RedCap UE 305 and inform (342) the threshold to the one or more RedCap UE 305. The threshold may be set based on one or more sidelink measurement reports (step 338) and UE positions of the one or more RedCap UEs. In one embodiment, the LMF 130 may configure the threshold level of measured peer report over SL such that if the RedCap UE 305 detects a sidelink measurement report by another RedCap UE device (e.g., 110-2) over the SL above this threshold, then the RedCap UE 305 may back off from sidelink measurement reporting (i.e., skip step 338) to the network.

The anchor UE 310 may broadcast (344) the indication signal periodically, and then the RedCap UE 305 may measure (346) the indication signal at the sidelink interface. For further power saving, the RedCap UE 310 may only measure RSRP on the PSCCH. If the RSRP of the indication signal is below the threshold, the RedCap UE 305 may perform (348) the positioning measurement at the Uu interface. Then, the RedCap UE 305 may report (350) the measured results to the LMF 130, for example, including UE type, SL capability, and positioning accuracy requirement.

If the measured RSRP of the indication signal is larger than the threshold, the RedCap UE 305 may stop the positioning measurement or stop the reporting thereof at the Uu interface to achieve power saving. The anchor UE 310, however, may keep on performing positioning at the Uu interface.

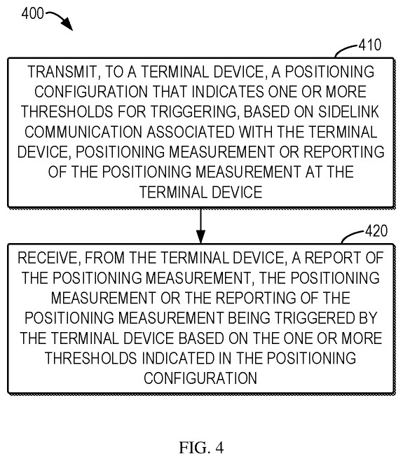

FIG. 4 shows a flowchart of an example method 400 implemented at the network node 120 in accordance with some example embodiments of the present disclosure. For the purpose of discussion, the method 400 will be described with reference to FIGS. 1 and 3.

At block 410, the network node 120 may transmit, to the terminal device 110, a positioning configuration that indicates one or more thresholds (e.g., step 342). The one or more thresholds are used for triggering, based on sidelink communication associated with the terminal device 110 (steps 344, 346), positioning measurement (step 348) or reporting (step 350) of the positioning measurement at the terminal device 110.

At block 420, the network node 120 may receive, from the terminal device 110, a report (step 350) of the positioning measurement (step 348). The positioning measurement (348) or the reporting (350) is triggered by the terminal device 110 based on the one or more thresholds (340) indicated in the positioning configuration (342).

In some example embodiments, the positioning measurement may be performed by the terminal device 110 via an interface between the terminal device 110 and the network node 120.

In some example embodiments, the reporting (350) of the positioning measurement (348) may take place subsequent to the positioning measurement within a defined time duration.

In some example embodiments, the sidelink communication associated with the terminal device may include sidelink measurement (346) of an indication signal communicated from the anchor node 115 via sidelink (344).

In some example embodiments, the network node 120 may forward a sidelink measurement report (338) of the indication signal (336) from the terminal device 110 to the LMF 130.

In some example embodiments, the network node 120 may receive the report of the positioning measurement (348) from the terminal device 110 when a measured result of the indication signal communicated via sidelink is below the one or more thresholds (340).

In some example embodiments, the network node 120 may transmit a PRS to the terminal device 110. The report of the positioning measurement by the terminal device 110 may include a second positioning measurement report (320, 324, 348) of the PRS. Alternatively, or in addition, the network node 120 may forward the second positioning measurement report (322 or 326 or 350) from the terminal device 110 to the LMF 130.

In some example embodiments, the network node 120 or the LMF 130 may determine or set the one or more threshold (step 340) indicated in the positioning configuration (step 342), based on a lowest level of sidelink measurement of an indication signal (step 336) in respective sidelink measurement reports (step 338) from a plurality of terminal devices 110-1 to 110-N.

In some example embodiments, the indication signal (steps 334, 344) may be periodically broadcasted by an anchor node 310 via sidelink to each terminal device of the plurality of terminal devices 110-1 to 110-N.

In some example embodiments, the network node 120 may transmit, to the anchor node 115, a configuration of periodic resources to broadcast the indication signal (step 332).

In some example embodiments, the measured results of the positioning measurement (348) may include one or more of: a TDOA, an AOD and a RSRP.

In some example embodiments, the interface between the terminal device 110 and the network node 120 may include a NR-Uu interface.

All operations and features related to the network node 120 as described above with reference to FIGS. 1 to 3 are likewise applicable to the method 400 and have similar effects. For the purpose of simplification, the details will be omitted.

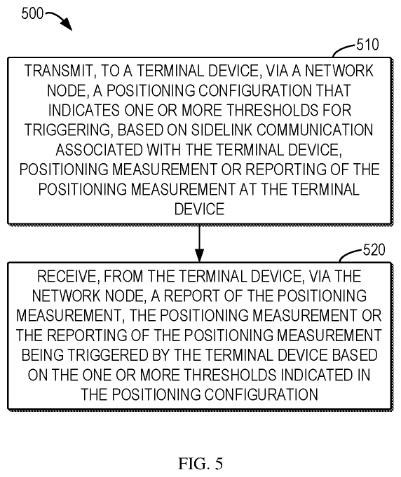

FIG. 5 shows a flowchart of an example method 500 implemented at the LMF 130 in accordance with some example embodiments of the present disclosure. For the purpose of discussion, the method 500 will be described from the perspective of the LMF 130 in FIG. 1.

At block 510, the LMF 130 may transmit, to the terminal device 110, via the network node 120, a positioning configuration (342) that indicates one or more thresholds. The one or more thresholds are used for triggering, based on the sidelink communication associated with the terminal device 110, positioning measurement (348) or reporting (350) of the positioning measurement at the terminal device 110.

At block 520, the LMF 130 may receive, from the terminal device 110, via the network node 120, a report (350) of the positioning measurement. The positioning measurement (348) or the reporting (350) of the positioning measurement is triggered (346) by the terminal device 110 based on the one or more thresholds indicated in the positioning configuration (342).

In some example embodiments, the LMF 130 may receive a sidelink measurement report (338) of the indication signal from the terminal device 110 via the network node 120.

In some example embodiments, the LMF 130 may receive the report (350) of the positioning measurement from the terminal device 110 via the network node 120 if a measured result of an indication signal (346) communicated via sidelink (344) is below the one or more thresholds (340).

In some example embodiments, a second reporting of the positioning measurement (322, 326, 350) may include a second measurement (320, 324, 348) report of a positioning reference signal received by the terminal device 110 from the network node 120.

In some example embodiments, the LMF 130 may determine the one or more threshold (340) indicated in the positioning configuration (342), based on a lowest level of sidelink measurement of an indication signal (336) in sidelink measurement reports (338) from a plurality of terminal devices 110-1 to 110-N.

All operations and features related to the LMF 130 as described above with reference to FIGS. 1 to 4 are likewise applicable to the method 500 and have similar effects. For the purpose of simplification, the details will be omitted.

In some example embodiments, an apparatus capable of performing the method 200 (for example, the terminal device 110 in FIG. 1) may include means for performing the respective operations of the method 200. The means may be implemented in any suitable form. For example, the means may be implemented in a circuitry or software module. The apparatus may be implemented as or included in the terminal device 110 in FIG. 1.

In some example embodiments, the apparatus includes means for receiving a positioning configuration that indicates one or more thresholds for triggering, based on sidelink communication associated with the terminal device, positioning measurement or reporting of the positioning measurement at the terminal device; and means for triggering the positioning measurement or the reporting of the positioning measurement based on the one or more thresholds indicated in the positioning configuration.

In some example embodiments, the means for triggering the positioning measurement or the reporting of the positioning measurement based on the one or more thresholds indicated in the positioning configuration includes: means for triggering switching between a sidelink interface and an interface between the terminal device and a network node for the positioning measurement or the reporting of the positioning measurement.

In some example embodiments, the means for triggering the positioning measurement or the reporting of the positioning measurement includes at least one of the following: means for stopping the positioning measurement or stop the positioning measurement reporting via an interface between the terminal device and the network node; or means for performing the positioning measurement or report the positioning measurement via the interface between the terminal device and the network node.

In some example embodiments, the reporting of the positioning measurement takes place subsequent to the positioning measurement within a defined time duration.

In some example embodiments, the sidelink communication associated with the terminal device includes: first measurement by the terminal device, of an indication signal communicated from an anchor node via sidelink.

In some example embodiments, the apparatus further includes: means for transmitting a sidelink measurement report of the indication signal, via an interface between the terminal device and a network node, to a location management function, LMF.

In some example embodiments, the apparatus further includes: means for receiving a sidelink measurement report of the indication signal over sidelink; and means for skipping a transmission of a sidelink measurement report of the indication signal when a level of sidelink measurement of the indication signal at the first device is higher than a detected level of sidelink measurement of the indication signal in the received sidelink measurement report.

In some example embodiments, the means for triggering the positioning measurement or the reporting of the positioning measurement includes one of: means for triggering the positioning measurement or the reporting of the positioning measurement via an interface between the terminal device and a network node when a measured result of an indication signal communicated via sidelink is below the one or more thresholds; or means for stopping the positioning measurement or stop the reporting of the positioning measurement via the interface between the terminal device and the network node when the measured result of the indication signal communicated via the sidelink is greater than or equal to the one or more thresholds.

In some example embodiments, the means for triggering the positioning measurement or the reporting of the positioning measurement includes: means for measuring a positioning reference signal, PRS, over an interface between the terminal device and a network node; and/or, means for transmitting a positioning measurement report of the positioning reference signal to a location management function, LMF.

In some example embodiments, the one or more threshold indicated in the positioning configuration are determined by a network node or by a location management function, based on a lowest level of sidelink measurement of an indication signal in sidelink measurement reports from a plurality of terminal devices.

In some example embodiments, the indication signal is periodically broadcasted by an anchor node via sidelink to each terminal device of the plurality of terminal devices.

In some example embodiments, measured results of the positioning measurement include one or more of: a time difference of arrival (TDOA), an angle of departure (AOD) and a reference signal received power (RSRP).

In some example embodiments, the interface between the terminal device and the network node includes a NR-Uu interface to communicate with the network node.

In some example embodiments, the apparatus further includes means for performing other operations in some example embodiments of the method 200 or the terminal device 110. In some example embodiments, the means includes at least one processor; and at least one memory storing instructions that, when executed by the at least one processor, cause the performance of the apparatus.

In some example embodiments, an apparatus capable of performing the method 300 (for example, the network node 120 in FIG. 1) may include means for performing the respective operations of the method 400. The means may be implemented in any suitable form. For example, the means may be implemented in a circuitry or software module. The second apparatus may be implemented as or included in the network node 120 in FIG. 1.

In some example embodiments, the apparatus includes means for transmitting, to a terminal device, a positioning configuration that indicates one or more thresholds for triggering, based on sidelink communication associated with the terminal device, positioning measurement or reporting of the positioning measurement at the terminal device; and means for receiving, from the terminal device, a report of the positioning measurement, the positioning measurement or the reporting of the positioning measurement being triggered by the terminal device based on the one or more thresholds indicated in the positioning configuration.

In some example embodiments, the positioning measurement is performed by the terminal device via an interface between the terminal device and the network node.

In some example embodiments, the reporting of the positioning measurement takes place subsequent to the positioning measurement within a defined time duration.

In some example embodiments, sidelink communication associated with the terminal device includes: sidelink measurement of an indication signal communicated from an anchor node via sidelink.

In some example embodiments, the apparatus further includes: means for forwarding a sidelink measurement report of the indication signal from the terminal device to a location management function, LMF.

In some example embodiments, the means for receiving the report of the positioning measurement includes: means for receiving the report of the positioning measurement from the terminal device if a measured result of an indication signal communicated via sidelink is below the one or more thresholds.

In some example embodiments, the apparatus further includes: means for transmitting a positioning reference signal, PRS, to the terminal device, wherein the report of the positioning measurement includes a positioning measurement report of the positioning reference signal; and/or, means for forwarding the positioning measurement report from the terminal device to a location management function, LMF.

In some example embodiments, the apparatus further includes: means for determining the one or more threshold indicated in the positioning configuration, based on a lowest level of sidelink measurement of an indication signal in sidelink measurement reports from a plurality of terminal devices.

In some example embodiments, the indication signal is periodically broadcasted by an anchor node via sidelink to each terminal device of the plurality of terminal devices.

In some example embodiments, the apparatus further includes: means for transmitting, to the anchor node, a configuration of periodic resources to broadcast the indication signal.

In some example embodiments, measured results of the positioning measurement include one or more of: a time difference of arrival (TDOA), an angle of departure (AOD) and a reference signal received power (RSRP).

In some example embodiments, an interface between the terminal device and the network node includes a NR-Uu interface.

In some example embodiments, the apparatus further includes means for performing other operations in some example embodiments of the method 400 or the network node 120. In some example embodiments, the means includes at least one processor; and at least one memory storing instructions that, when executed by the at least one processor, cause the performance of the apparatus.

In some example embodiments, an apparatus capable of performing any of the method 500 (for example, the LMF 130 in FIG. 1 may include means for performing the respective operations of the method 500. The means may be implemented in any suitable form. For example, the means may be implemented in a circuitry or software module. The third apparatus may be implemented as or included in the LMF 130 in FIG. 1.

In some example embodiments, the apparatus includes means for transmitting, to a terminal device, via a network node, a positioning configuration that indicates one or more thresholds for triggering, based on sidelink communication associated with the terminal device, positioning measurement or reporting of the positioning measurement at the terminal device; and means for receiving, from the terminal device, via the network node, a report of the positioning measurement, the positioning measurement or the reporting of the positioning measurement being triggered by the terminal device based on the one or more thresholds indicated in the positioning configuration.

In some example embodiments, the positioning measurement is performed by the terminal device via an interface between the terminal device and the network node.

In some example embodiments, an interface between the terminal device and the network node includes a NR-Uu interface.

In some example embodiments, the reporting of the positioning measurement takes place subsequent to the positioning measurement within a defined time duration.

In some example embodiments, the sidelink communication associated with the terminal device includes: sidelink measurement of an indication signal communicated from an anchor node via sidelink.

In some example embodiments, the apparatus further includes: means for receiving a sidelink measurement report of the indication signal from the terminal device via the network node.

In some example embodiments, the means for receiving the report of the positioning measurement includes: means for receiving the report of the positioning measurement from the terminal device via the network node if a measured result of an indication signal communicated via sidelink is below the one or more thresholds.

In some example embodiments, the report of the positioning measurement includes a positioning measurement report of a positioning reference signal received by the terminal device from the network node.

In some example embodiments, the apparatus further includes: means for determining the one or more threshold indicated in the positioning configuration, based on a lowest level of sidelink measurement of an indication signal in sidelink measurement reports from a plurality of terminal devices.

In some example embodiments, the indication signal is periodically broadcasted by an anchor node via sidelink to each terminal device of the plurality of terminal devices.

In some example embodiments, measured results of the positioning measurement include one or more of: a time difference of arrival (TDOA), an angle of departure (AOD) and a reference signal received power (RSRP).

In some example embodiments, the apparatus further includes means for performing other operations in some example embodiments of the method 500 or the LMF 130. In some example embodiments, the means includes at least one processor; and at least one memory storing instructions that, when executed by the at least one processor, cause the performance of the apparatus.

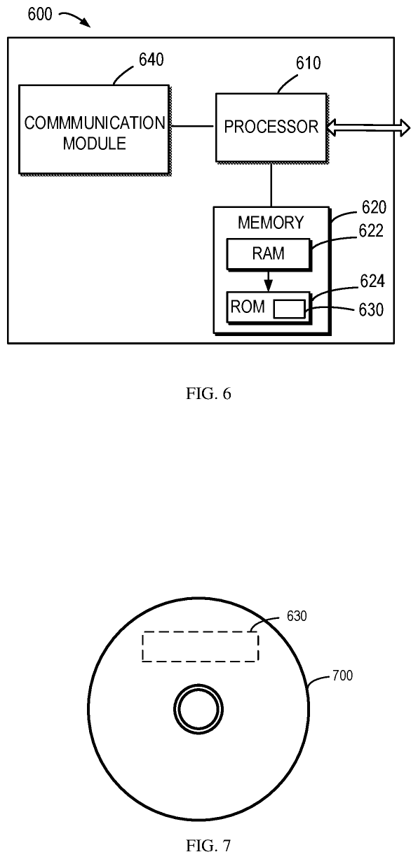

FIG. 6 is a simplified block diagram of a device 600 that is suitable for implementing example embodiments of the present disclosure. The device 600 may be provided to implement a communication device, for example, the terminal device 110, the network node 120, or the LMF 130 as shown in FIG. 1. As shown, the device 600 includes one or more processors 610, one or more memories 620 coupled to the processor 610, and one or more communication modules 640 coupled to the processor 610.

The communication module 640 is for bidirectional communications. The communication module 640 has one or more communication interfaces to facilitate communication with one or more other modules or devices. The communication interfaces may represent any interface that is necessary for communication with other network elements. In some example embodiments, the communication module 640 may include at least one antenna.

The processor 610 may be of any type suitable to the local technical network and may include one or more of the following: general purpose computers, special purpose computers, microprocessors, digital signal processors (DSPs) and processors based on multicore processor architecture, as non-limiting examples. The device 600 may have multiple processors, such as an application specific integrated circuit chip that is slaved in time to a clock which synchronizes the main processor.

The memory 620 may include one or more non-volatile memories and one or more volatile memories. Examples of the non-volatile memories include, but are not limited to, a Read Only Memory (ROM) 624, an electrically programmable read only memory (EPROM), a flash memory, a hard disk, a compact disc (CD), a digital video disk (DVD), an optical disk, a laser disk, and other magnetic storage and/or optical storage. Examples of the volatile memories include, but are not limited to, a random access memory (RAM) 622 and other volatile memories that will not last in the power-down duration.

A computer program 630 includes computer executable instructions that are executed by the associated processor 610. The instructions of the program 630 may include instructions for performing operations/acts of some example embodiments of the present disclosure. The program 630 may be stored in the memory, e.g., the ROM 624. The processor 610 may perform any suitable actions and processing by loading the program 630 into the RAM 622.

The example embodiments of the present disclosure may be implemented by means of the program 630 so that the device 600 may perform any process of the disclosure as discussed with reference to FIG. 1 to FIG. 5. The example embodiments of the present disclosure may also be implemented by hardware or by a combination of software and hardware.

In some example embodiments, the program 630 may be tangibly contained in a computer readable medium which may be included in the device 600 (such as in the memory 620) or other storage devices that are accessible by the device 600. The device 600 may load the program 630 from the computer readable medium to the RAM 622 for execution. In some example embodiments, the computer readable medium may include any types of non-transitory storage medium, such as ROM, EPROM, a flash memory, a hard disk, CD, DVD, and the like. The term “non-transitory,” as used herein, is a limitation of the medium itself (i.e., tangible, not a signal) as opposed to a limitation on data storage persistency (e.g., RAM vs. ROM).

FIG. 7 shows an example of the computer readable medium 700 which may be in form of CD, DVD or other optical storage disk. The computer readable medium 700 has the program 630 stored thereon.

Generally, various embodiments of the present disclosure may be implemented in hardware or special purpose circuits, software, logic or any combination thereof. Some aspects may be implemented in hardware, while other aspects may be implemented in firmware or software which may be executed by a controller, microprocessor or other computing device. While various aspects of embodiments of the present disclosure are illustrated and described as block diagrams, flowcharts, or using some other pictorial representations, it is to be understood that the block, apparatus, system, technique or method described herein may be implemented in, as non-limiting examples, hardware, software, firmware, special purpose circuits or logic, general purpose hardware or controller or other computing devices, or some combination thereof.

Some example embodiments of the present disclosure also provide at least one computer program product tangibly stored on a computer readable medium, such as a non-transitory computer readable medium. The computer program product includes computer-executable instructions, such as those included in program modules, being executed in a device on a target physical or virtual processor, to carry out any of the methods as described above. Generally, program modules include routines, programs, libraries, objects, classes, components, data structures, or the like that perform particular tasks or implement particular abstract data types. The functionality of the program modules may be combined or split between program modules as desired in various embodiments. Machine-executable instructions for program modules may be executed within a local or distributed device. In a distributed device, program modules may be located in both local and remote storage media.

Program code for carrying out methods of the present disclosure may be written in any combination of one or more programming languages. The program code may be provided to a processor or controller of a general purpose computer, special purpose computer, or other programmable data processing apparatus, such that the program code, when executed by the processor or controller, cause the functions/operations specified in the flowcharts and/or block diagrams to be implemented. The program code may execute entirely on a machine, partly on the machine, as a stand-alone software package, partly on the machine and partly on a remote machine or entirely on the remote machine or server.

In the context of the present disclosure, the computer program code or related data may be carried by any suitable carrier to enable the device, apparatus or processor to perform various processes and operations as described above. Examples of the carrier include a signal, computer readable medium, and the like.

The computer readable medium may be a computer readable signal medium or a computer readable storage medium. A computer readable medium may include but not limited to an electronic, magnetic, optical, electromagnetic, infrared, or semiconductor system, apparatus, or device, or any suitable combination of the foregoing. More specific examples of the computer readable storage medium would include an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing.

Further, while operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, while several specific implementation details are contained in the above discussions, these should not be construed as limitations on the scope of the present disclosure, but rather as descriptions of features that may be specific to particular embodiments. Unless explicitly stated, certain features that are described in the context of separate embodiments may also be implemented in combination in a single embodiment. Conversely, unless explicitly stated, various features that are described in the context of a single embodiment may also be implemented in a plurality of embodiments separately or in any suitable sub-combination.

Although the present disclosure has been described in languages specific to structural features and/or methodological acts, it is to be understood that the present disclosure defined in the appended claims is not necessarily limited to the specific features or acts described above. Rather, the specific features and acts described above are disclosed as example forms of implementing the claims.

1-76. (canceled)

77. A terminal device, comprising:
at least one processor; and
at least one memory storing instructions that, when executed by the at least one processor, cause the terminal device at least to:
receive a positioning configuration that indicates one or more thresholds for triggering, based on sidelink communication associated with the terminal device, positioning measurement or reporting of the positioning measurement at the terminal device;
trigger the positioning measurement or the reporting of the positioning measurement based on the one or more thresholds indicated in the positioning configuration.

78. The terminal device according to claim 77, wherein trigger the positioning measurement or the reporting of the positioning measurement based on the one or more thresholds indicated in the positioning configuration comprises:
trigger switching between a sidelink interface and an interface between the terminal device and a network node for the positioning measurement or the reporting of the positioning measurement.

79. The terminal device according to claim 77, wherein trigger the positioning measurement or the reporting of the positioning measurement comprises at least one of the following:
stop the positioning measurement or stop the reporting of the positioning measurement via an interface between the terminal device and the network node; or
perform the positioning measurement or report the positioning measurement via the interface between the terminal device and the network node.

80. The terminal device according to claim 77, wherein the reporting of the positioning measurement takes place subsequent to the positioning measurement within a defined time duration.

81. The terminal device according to claim 77, wherein the sidelink communication associated with the terminal device comprises:
sidelink measurement by the terminal device, of an indication signal communicated from an anchor node via sidelink.

82. The terminal device according to claim 81, wherein the terminal device is further caused to:
transmit a sidelink measurement report of the indication signal, via an interface between the terminal device and a network node, to a location management function, LMF.

83. The terminal device according to claim 81, wherein the first device is further caused to:
receive a sidelink measurement report of the indication signal over sidelink; and
skip a transmission of a sidelink measurement report of the indication signal when a level of sidelink measurement of the indication signal at the first device is higher than a detected level of sidelink measurement of the indication signal in the received sidelink measurement report.

84. The terminal device according to claim 77, wherein trigger the positioning measurement or the reporting of the positioning measurement comprises one of:
trigger the positioning measurement or the reporting of the positioning measurement via an interface between the terminal device and a network node when a measured result of an indication signal communicated via sidelink is below the one or more thresholds; or
stop the positioning measurement or stop the reporting of the positioning measurement via the interface between the terminal device and the network node when the measured result of the indication signal communicated via the sidelink is greater than or equal to the one or more thresholds.

85. The terminal device according to claim 81, wherein the one or more thresholds indicated in the positioning configuration are determined by a network node or by a location management function, based on a lowest level of sidelink measurement of the indication signal in sidelink measurement reports from a plurality of terminal devices.

86. The terminal device according to claim 85, wherein the indication signal is periodically broadcasted by an anchor node via sidelink to each terminal device of the plurality of terminal devices.

87. The terminal device according to claim 77, wherein trigger the positioning measurement or the reporting of the positioning measurement comprises:
measure a positioning reference signal, PRS, over an interface between the terminal device and a network node; and/or,
transmit a positioning measurement report of the positioning reference signal to a location management function, LMF.

88. The terminal device according to claim 77, wherein measured results of the positioning measurement comprise one or more of: a time difference of arrival (TDOA), an angle of departure (AOD) and a reference signal received power (RSRP).

89. The terminal device according to claim 78, wherein the interface between the terminal device and the network node comprises a NR-Uu interface to communicate with the network node.

90. A network node, comprising:
at least one processor; and
at least one memory storing instructions that, when executed by the at least one processor, cause the network node at least to:
transmit, to a terminal device, a positioning configuration that indicates one or more thresholds for triggering, based on sidelink communication associated with the terminal device, positioning measurement or reporting of the positioning measurement at the terminal device; and
receive, from the terminal device, a report of the positioning measurement, the positioning measurement or the reporting of the positioning measurement being triggered by the terminal device based on the one or more thresholds indicated in the positioning configuration.

91. The network node according to claim 90, wherein the positioning measurement is performed by the terminal device via an interface between the terminal device and the network node.

92. The network node according to claim 90, wherein the reporting of the positioning measurement takes place subsequent to the positioning measurement within a defined time duration.

93. The network node according to claim 90, wherein the sidelink communication associated with the terminal device comprises:
sidelink measurement of an indication signal communicated from an anchor node via sidelink.

94. The network node claim 93, wherein the network node is further caused to:
forward a sidelink measurement report of the indication signal from the terminal device to a location management function, LMF.

95. The network node according to claim 90, wherein receive the report of the positioning measurement comprises:
receive the report of the positioning measurement from the terminal device when a measured result of an indication signal communicated via sidelink is below the one or more thresholds.

96. A location management function, comprising:
at least one processor; and
at least one memory storing instructions that, when executed by the at least one processor, cause the location management function at least to:
transmit, to a terminal device, via a network node, a positioning configuration that indicates one or more thresholds for triggering, based on sidelink communication associated with the terminal device, positioning measurement or reporting of the positioning measurement at the terminal device; and
receive, from the terminal device, via the network node, a report of the positioning measurement, the positioning measurement or the reporting of the positioning measurement being triggered by the terminal device based on the one or more thresholds indicated in the positioning configuration.
